(19) United States
(12) Patent Application Publication
(10) Pub. No.: US 2026/0131972 A1
(43) Pub. Date: May 14, 2026

(54) METHOD FOR ORDER PREPARATION

(71) Applicant: EXOTEC PRODUCT FRANCE, Croix (FR)

(72) Inventors: Romain MOULIN, Lille (FR); Renaud HEITZ, Villeneuve d'Ascq (FR); Marc CHATAIN, Zimmerbach (FR)

(73) Assignee: EXOTEC PRODUCT FRANCE, Croix (FR)

(21) Appl. No.: 19/121,479

(22) PCT Filed: Oct. 20, 2023
(86) PCT No.: PCT/EP2023/079341

§ 371 Date: Apr. 16, 2025

(30) Foreign Application Priority Data
Oct. 21, 2022 (FR) FR2210960

(51) Int. Cl. B65G 1/04; B65G 1/137

(52) U.S. Cl. CPC B65G 1/0492; B65G 1/0478; B65G 1/1378

(57) ABSTRACT

A method for order preparation, which includes moving a motorized vehicle across the floor in a transit zone at least in a first horizontal direction so as to align the vehicle, in a second horizontal direction, with a passageway of a storage area; and moving the vehicle in the passageway in the second horizontal direction until the vehicle is positioned in an aisle of the storage area which serves a rack where the collection cell is located; the vehicle being configured to move freely across the floor and the orientation of the vehicle remaining fixed during the method.

### TECHNICAL FIELD

This description relates to the field of methods for order preparation.

### PRIOR ART

Traditionally, in the field of logistics and more specifically of order preparation in a warehouse, a human operator moves about in the warehouse in order to collect one or more items for the order from various racks in the warehouse. The operator may be required to cover long distances, which causes fatigue. Also, the operator must be completely familiar with the rack layout in the warehouse, to avoid following an unoptimized and therefore longer route, which would increase the order preparation time.

To limit operator fatigue and reduce order preparation time, it is known to use a fleet of motorized vehicles. Each vehicle may thus travel around the warehouse along an optimized route in order to collect the items in the order. Also, order preparation increasingly involves the use of motorized vehicles with automated guidance (commonly called “automated guided vehicles” or AGVs).

Guided vehicles are known that only move across the floor and are each configured to support a rack column. However, this method of collection has the disadvantage of moving the entire rack column, and therefore all of the items contained within it, even if only one or a few of the items are to be collected. Such a vehicle must move slowly, to prevent the rack column from falling over. Furthermore, the height of the rack column carried by the vehicle must also be limited, in order to reduce the risk of falling items, which increases the number of columns required and therefore requires a costly, if not impossible, expansion of the warehouse's size.

Automated guided vehicles are also known that move across the floor and are adapted to climb vertically up a rack to collect an item.

Among these automated guided vehicles, the first known vehicles are those whose movement across the floor is restricted by rails leading to the warehouse racks. However, such a solution has the disadvantage of being inflexible and not allowing the racks to be rearranged easily and without interrupting production, when needing to adapt to requirements (in the event of growth in the business, for example).

Then there are automated guided vehicles that move about freely (i.e. without rails). Generally, such vehicles change their direction of movement by pivoting the entire vehicle. In other words, these vehicles pivot on their own vertical axis. To achieve this, this type of vehicle comprises a pair of coaxial wheels mounted on a chassis and driven to rotate in opposite directions so as to pivot the chassis about the vertical axis. However, it has been observed that a vehicle pivoting in this manner requires precise recalibration of the spatial position of the chassis after the change of direction. Such recalibration increases the order preparation time and could result in an error that would lead to an incorrect path for the robot. Furthermore, in order to transport a standard parallelepiped-shaped container, the vehicles typically have an adapted non-circular shape. Therefore, in order to change direction by pivoting on itself, the vehicle requires more floor space than the surface area it occupies due to its own dimensions. Consequently, to ensure the simultaneous pivoting of two vehicles at an intersection where they must change direction, it is necessary either to increase the width of the lanes for vehicle traffic and therefore to expand the size of the warehouse, or limit the number of vehicles moving about near the racks, which de facto limits the order preparation rate.

The present description aims in particular to provide a simple, economical, and effective solution to the problems mentioned above, making it possible to avoid the disadvantages of the known automated guided vehicles.

### SUMMARY

The present invention therefore consists in particular of a method for preparing an order by means of at least one motorized vehicle moving between a storage area and a transit zone, the method comprising the steps of:
a. Associating the vehicle located in an initial position in the transit zone with a container to be collected in the storage area, the container being arranged inside a collection cell among a plurality of cells of the storage area;
   according to a first possibility, the method comprising the steps of:
bi. Moving the vehicle across the floor in the transit zone at least in a first horizontal direction so as to align the vehicle, in a second horizontal direction, with a passageway in the storage area;
ci. Making at least one change of direction;
di. Moving the vehicle across the floor in at least one passageway in the second horizontal direction until the vehicle is located in an aisle of the storage area, preferably an aisle which serves a rack where the collection cell is located;

According to a second possibility, the method comprises the steps of:
bii. Moving the vehicle across the floor in at least one passageway in the second horizontal direction until the vehicle is located in an aisle of the storage area, preferably the aisle which serves the rack where the collection cell is located;
cii. Making at least one change of direction;
dii. Moving the vehicle across the floor in the aisle of the storage area, preferably the aisle serving the rack where the collection cell is located, in the first horizontal direction, so as to align the vehicle, in the second horizontal direction, with the collection cell;
   the method further comprising the steps of:
e. Moving the vehicle in a vertical direction until the vehicle is vertically located at the level of the collection cell;
f. Loading onto the vehicle the container held in the collection cell, by means of the vehicle's gripping means;
g. Moving the vehicle in a vertical direction until the vehicle is at floor level;
   and wherein:
the vehicle is configured to move freely across the floor, the floor having no rails for guidance in the two perpendicular directions,
the orientation of the vehicle remains fixed during its movement across the floor in the transit zone and in the storage area during steps bi, bii, di, and dii, including during the change of direction made in steps ci and cii, and preferably during steps e and g.

The vehicle thus does not rotate its chassis during the method for order preparation, in particular during the 90° change of direction in the movement of the vehicle during steps ci and cii. Thus, the movement of the vehicle requires less floor space during its path to the collection cell, in particular during the 90° change of direction in the movement of the vehicle between step bi and step di and between step bii and step dii. Also, the floor space occupied by the vehicle during the 90° change of direction between the first horizontal direction and the second horizontal direction is reduced by a factor equal to √2 compared to a vehicle whose chassis rotates during a 90° change of direction. Thus, it is possible to route through the transit zone a fleet of vehicles identical to the vehicle described above while advantageously increasing the number of vehicles in transit at the same time. As a result, the order preparation rate can be increased.

Furthermore, having no rotation of the vehicle chassis makes it possible to reduce or even eliminate recalibrating the position of the robot chassis relative to the environment (relative to the rack, for example) after the 90° change of direction between the movement in the first horizontal direction of step bi and the movement in the second horizontal direction of step di, and between the movement in the second horizontal direction of step bii and the movement in the first horizontal direction of step dii. The movement of the vehicle is therefore more precise and easier to implement. Also, the method for order preparation as described above is carried out more quickly, which also allows increasing the order preparation rate.

It is noteworthy that the vehicle's means for horizontal movement allow the vehicle chassis to move freely across the floor. It is understood here that the storage area and the transit zone are each without any rails for guiding the vehicle. Such a mode of vehicle movement allows for faster and more flexible installation of the storage area and transit zone. Finally, the noise footprint is also reduced, providing increased comfort for the human operators working in the storage area and/or in the transit zone.

It is understood that the vertical direction is perpendicular to the first horizontal direction and second horizontal direction. Also, the first axis of extension of the chassis is perpendicular to the vertical direction.

The container may have a parallelepipedal shape.

The change of direction in step ci may be carried out in the transit zone. The change of direction in step cii may be carried out in the storage area, preferably in the aisle serving the rack where the collection cell is located.

Step bi may comprise the subsidiary steps of:
bi1 Moving the motorized vehicle across the floor in the transit zone, in the first horizontal direction;
bi2 Moving the motorized vehicle across the floor in the transit zone, in the second horizontal direction;
bi3 Moving the motorized vehicle across the floor in the transit zone, in the first horizontal direction, so as to align the vehicle, in the second horizontal direction, with the passageway that comprises the free space formed by the column where the collection cell is located.

According to a variant, steps bi1 and bi2 may be repeated one or more times before step bi3. Step bi may include a step of changing the direction (of the movement of the vehicle) between each of steps bi1 and bi2, and between the last step bi2 (this may be step bi2 in the case where steps bi1 and bi2 are carried out only once) and step bi3. The first possibility may also comprise steps prior to step bi, comprising one (or more) movements of the vehicle in the transit zone, in particular in the second horizontal direction.

Where appropriate, the movement of the vehicle in step di may be carried out partly in the transit zone before being carried out in the corresponding passageway.

The first possibility may comprise an additional step carried out after step di and which comprises movement of the vehicle in the first horizontal direction in the aisle of the storage area serving the rack where the collection cell is located, in order to align the vehicle with the collection cell in the second horizontal direction.

Where appropriate, the movement of the vehicle in step bii may be carried out partly in the transit zone before being carried out in the corresponding passageway.

Step bii may comprise the subsidiary steps of:
bii1 Moving the vehicle across the floor in a first passageway in the second horizontal direction until the vehicle is located in a first aisle;
bii2 Moving the vehicle across the floor in the first aisle in the first horizontal direction until the vehicle is aligned in the second horizontal direction with a second passageway;
bii3 Moving the vehicle across the floor in the second passageway in the second horizontal direction until the vehicle is located in a second aisle, the second aisle preferably being the aisle serving the rack where the collection cell is located.

Alternatively, steps bii1 and bii2 may be repeated one or more times before step bii3. Step bii may comprise a step of changing the direction (of movement of the vehicle) between each of steps bii1 and bii2, and between the last step bii2 (this may be step bii2 in the case where steps bii1 and bii2 are carried out only once) and step bii3. The second possibility may also comprise steps prior to step bii, comprising one (or more) movements of the vehicle in the transit zone.

In the case where the aisle concerned in step dii is not coincident with the aisle serving the rack where the collection cell is located, the second possibility may comprise an additional step carried out after step dii and which comprises movement of the vehicle across the floor in the second horizontal direction in another passageway until the vehicle is located in the aisle serving the rack where the collection cell is located.

The method may comprise the first possibility (steps bi, ci, and di) and/or the second possibility (steps bii, cii, and dii). In other words, the method may be a combination of the first possibility and second possibility.

Step a may comprise the subsidiary steps of:
a1 Selecting the container to be collected in the storage area, the container being arranged inside the collection cell among the cells of the storage area;
a2 Establishing communication with the vehicle located in the initial position in the transit zone, for example by means of a wireless communication network such as WiFi, WiMAX, IWLAN, GSM, GPRS, UMTS (registered trademarks);

The vehicle may comprise:
a chassis extending along a first horizontal axis of extension;
means for horizontal movement, adapted to move the chassis across the floor in at least two perpendicular directions while maintaining a fixed orientation of the first axis of extension of the chassis, the means for horizontal movement being configured to move freely across the floor which has no rails for guidance in the two perpendicular directions;
climbing means adapted to move the chassis along the vertical direction; and
gripping means connected to the chassis and adapted to grasp a container in a cell and load it onto the chassis.

The orientation of the first axis of extension of the chassis of the vehicle therefore remains fixed during steps bi, bii, di, and dii, as well as during the change of direction in steps ci and cii, and preferably during steps e and g. Preferably, the orientation of the vehicle remains fixed throughout its route, in particular on the floor, in the transit zone and storage area. More preferably, the orientation of the vehicle remains fixed throughout the method for order preparation.

The direction of the first axis of extension of the vehicle chassis may comprise a component in the first horizontal direction and/or a component in the second horizontal direction. Thus, during the method for order preparation as described above, the component in the first horizontal direction and/or the component in the second horizontal direction of the first axis of extension of the vehicle chassis does not vary. The orientation of the first axis of extension of the vehicle chassis remains fixed in particular during the movement of the vehicle in the first horizontal direction in steps bi and dii, during the movement of the vehicle in the second horizontal direction in steps di and bii, and during the 90° change of direction in the movement in steps ci and cii.

The means for horizontal movement of the vehicle may comprise at least one wheel assembly which comprises:
a wheel having an axis of revolution perpendicular to the vertical direction, and connecting means for connecting the wheel to the chassis, the axis of revolution of the wheel which the wheel rotates around in order to move the vehicle extending at least in the second horizontal direction during steps bi and dii and in the first horizontal direction during steps di and bii;
means for changing the direction of movement, comprising pivoting means for pivoting the wheel and the connecting means about a vertical axis relative to the chassis, the vertical axis intersecting the axis of revolution of the wheel.

Steps ci and cii may comprise pivoting the wheel and connecting means about the vertical axis so as to pivot the axis of revolution of the wheel about the vertical axis, between the second horizontal direction and the first horizontal direction.

Changing the direction of movement of the vehicle by 90° between the first horizontal direction and the second horizontal direction, by turning only the wheel and the wheel connecting means, is advantageously faster than turning the entire chassis of the vehicle. In particular, a gain of 2 seconds has been observed for a 90° change of direction in the movement of the vehicle. The order preparation rate is therefore further increased.

The vertical axis extends in the vertical direction.

The connecting means may comprise a wheel fork on which the wheel is mounted so as to pivot about its axis of revolution. The connecting means, in particular the fork, may comprise two flanges and a shaft. The flanges may be arranged one on either side of the wheel along the direction of the wheel's axis of revolution. The shaft may extend along the axis of revolution of the wheel, between the flanges. The shaft may be fixed to the flanges. The shaft may pass through a hole in each of the flanges and be secured to the flanges by a nut which engages with a threaded portion of the shaft. The wheel may be mounted on the shaft so as to pivot about its axis of revolution.

The pivoting means of the wheel may comprise a toothed wheel fixed to the wheel fork and mounted so as to pivot about the vertical pivot axis of the wheel, a worm screw meshing with the toothed wheel.

The wheel may be blocked from rotating about its axis of revolution during step c.

Thus, the orientation of the vehicle remains fixed when the direction of movement of the vehicle changes by 90°. Also, it is not necessary for the drive means to act on the wheel to compensate for a rotation of the wheel about its axis of revolution as it is pivoting about the vertical axis. This reduces the vehicle's energy consumption.

In other words, step c is carried out without the wheel pivoting about the axis of revolution.

The wheel assembly may comprise drive means for rotating the wheel about its axis of revolution relative to the chassis, the drive means comprising a first bevel gear and a second bevel gear which are arranged relative to each other so as to form a bevel gearing, the first bevel gear being coaxial with the vertical axis and the second bevel gear being coaxial with the axis of revolution of the wheel, the wheel and the second bevel gear being arranged one on either side of the vertical axis, a relative difference between the ratio of the radius of the wheel and the distance along the axis of revolution that separates a centre plane of the wheel and the vertical axis, and the reduction ratio between the second bevel gear and the first bevel gear, being less than or equal to 2%.

Such an arrangement allows preventing the wheel from being rotated about its axis of revolution when it pivots about the vertical axis.

Due to the fact that the first bevel gear is coaxial with the vertical axis, it is understood that the first bevel gear comprises a plurality of teeth arranged annularly around the vertical axis. Similarly, due to the fact that the second bevel gear is coaxial with the axis of revolution of the wheel, it is understood that the second bevel gear comprises a plurality of teeth arranged annularly around the axis of revolution of the wheel.

The centre plane of the wheel is a plane perpendicular to the axis of revolution of the wheel and equidistant, along the axis of revolution of the wheel, from a first face and a second face of the wheel which are opposite each other along the direction of the axis of revolution of the wheel.

The reduction ratio between the second bevel gear and the first bevel gear corresponds to the ratio between the number of teeth of the second bevel gear and the number of teeth of the first bevel gear.

The means for horizontal movement of the vehicle may comprise a plurality of wheel assemblies. Step c may comprise simultaneously pivoting the wheel and connecting means of each wheel assembly about the corresponding vertical axis, so as to pivot the axis of revolution of the wheel of each wheel assembly about the vertical axis from the second horizontal direction to the first horizontal direction.

The chassis of the vehicle may be parallelepipedal in shape. The vehicle may comprise four wheel assemblies, each wheel assembly being arranged at a lower corner of the chassis.

The vehicle may comprise an actuator for actuating the pivoting means of each wheel assembly. Alternatively, each wheel assembly may comprise an actuator for actuating the pivoting means. The actuator may be adapted to rotate the worm screw about its axis of extension. The actuator may comprise a motor fixed to the chassis of the vehicle and which has an output shaft connected to the worm screw.

The vehicle may comprise an actuator for actuating the drive means of each wheel assembly. Alternatively, each wheel assembly may comprise an actuator for actuating the drive means.

The storage area may comprise several racks, each rack being served by at least one aisle extending in the first horizontal direction, each rack comprising a plurality of rack columns arranged one after the other in the first horizontal direction, each rack column comprising a plurality of storage cells adapted to contain a container which itself contains at least one item, the cells of each column being superimposed in several levels along the vertical direction between a bottom level and a top level, each column comprising a free space formed vertically between the floor level and the cell of the bottom level, the storage area comprising a plurality of passageways extending at floor level in the second horizontal direction which is perpendicular to the first perpendicular direction, each passageway passing through the free space of one of the columns of each rack. The transit zone may be adjacent to the storage area in the second horizontal direction.

According to a third possibility, the method may comprise the steps of:
biii. Moving the vehicle across the floor in at least a first passageway in the second horizontal direction until the vehicle is located under one of the racks, preferably under the bottom level of the first rack,
ciii. Making at least a first change of direction, preferably under the first rack,
diii. Moving the vehicle across the floor in the first horizontal direction under the first rack until the vehicle is located in a second passageway;
ciii′. Making at least a second change of direction, preferably under the second rack,
diii′. Moving the vehicle across the floor in the second passageway in the second horizontal direction until the vehicle is located in an aisle of the storage area, preferably the aisle serving a rack where the collection cell is located.

The orientation of the vehicle remains fixed during its movement across the floor in the transit zone and in the storage area during steps biii, dii, diii′, including during the changes of direction performed in step ciii, ciii′.

Steps ciii and ciii′ may comprise pivoting the wheel and the connecting means about the vertical axis so as to pivot the axis of revolution of the wheel about the vertical axis between the second horizontal direction and the first horizontal direction.

The method may comprise the first possibility and/or the second possibility and/or the third possibility. In other words, the method may be any combination of the first, second, and third possibilities.

The vehicle may comprise an automated guidance unit. The method may comprise the steps of:
a′ Transmitting the position of the collection cell to the automated guidance unit of the vehicle, the position of the collection cell being identified by the aisle serving the rack where the collection cell is located, the column of the rack where the collection cell is located, and the level at which the collection container is located in the column;
a″ Commanding the automated guidance unit of the vehicle to calculate a route between the initial position of the vehicle and the position of the collection cell, the route preferably comprising only a movement of the vehicle in the first horizontal direction and a movement of the vehicle in the second horizontal direction;
steps a′ and a″ being carried out between step a and step b.

The vehicle is then an automated guided vehicle (AGV).

The storage area and the transit zone may be provided with guidance tracing on the floor, intended to guide the vehicle across the floor, the guidance tracing comprising first rectilinear strips in the first horizontal direction and second rectilinear strips in the second horizontal direction. The route may be calculated in step a″ to follow a path selected among the first strips and the second strips.

The guidance tracing may thus form a grid.

The vehicle may comprise a first pair of sensors arranged one on either side of the vehicle in the first horizontal direction and a second pair of sensors arranged one on either side of the vehicle in the second horizontal direction. The sensors of the first pair of sensors may be mounted on the vehicle one on either side of the chassis along the first axis of extension and the sensors of the second pair of sensors may be mounted on the vehicle one on either side of the chassis along a second axis of extension that is perpendicular to the first axis.

Depending on the direction of movement of the vehicle, one among the first pair of sensors and second pair of sensors may be adapted to monitor the alignment of the vehicle in the first and the second horizontal direction respectively, and the other among the first pair of sensors and second pair of sensors may be adapted to identify the position of the vehicle in the first and the second horizontal direction respectively.

When the vehicle moves in the first horizontal direction:
the first pair of sensors may be adapted to detect a deviation or misalignment of the vehicle in the first horizontal direction relative to a first strip being followed by the vehicle. If necessary, the alignment of the vehicle in the first horizontal direction may be corrected; and
the second pair of sensors may be adapted to count the second strips that are crossed. Associated with a wheel revolution counter, the second pair of sensors may thus allow identifying the location of the vehicle in the second horizontal direction.

When the vehicle moves in the second horizontal direction:
the second pair of sensors may be adapted to detect a deviation or misalignment of the vehicle in the second horizontal direction relative to a second strip being followed by the vehicle. If necessary, the alignment of the vehicle in the second horizontal direction may be corrected; and
the first pair of sensors may be adapted to count the first strips that are crossed. Associated with a wheel revolution counter, the first pair of sensors may thus allow identifying the location of the vehicle in the first horizontal direction.

This ensures centred positioning on the strips. This also ensures that the vehicle can circulate through the storage area passageways without bumping into the rack uprights.

The sensors of the first pair of sensors and/or of the second pair of sensors may be optical sensors. In particular, they may be LED sensors, preferably 750 nm. The sensors of the first pair of sensors and/or of the second pair of sensors may be adapted to detect a colour difference between black and white. For this purpose, the first and second strips may comprise black borders that frame a white central portion.

The strips may be implemented as a covering fixed to the floor (e.g. by gluing) or may be painted directly on the floor. Each aisle of the storage area may be provided with one of the first strips in the first horizontal direction. Each passageway of the storage area may be provided with one of the second strips in the second horizontal direction.

Two adjacent second strips may be spaced apart from each other in the first horizontal direction, at least in the transit zone, by a distance of between 500 mm and 600 mm, preferably between 525 mm and 575 mm, and more preferably equal to 560 mm. A relative difference between the distance in the first horizontal direction separating two adjacent second strips in the transit zone and a dimension of the vehicle in the first horizontal direction may be between 0% (bound excluded) and 35%, preferably between 0% (bound excluded) and 30%, more preferably between 0% (bound excluded) and 25%. The first distance may be substantially greater than the sum of a dimension of the vehicle in the first horizontal direction and two times a dimension of a rack upright in the first horizontal direction.

Two adjacent first strips may be spaced apart from each other in the second horizontal direction, at least in the transit zone, by a distance of between 700 mm and 800 mm, preferably between 725 mm and 775 mm, and more preferably equal to 750 mm. A relative difference between the distance in the second horizontal direction separating two adjacent first strips in the transit zone and a dimension of the vehicle in the second horizontal direction may be between 0% (bound excluded) and 25%, preferably between 0% (bound excluded) and 20%, more preferably between 0% (bound excluded) and 15%.

The number of first strips and second strips in the transit zone may be higher, which makes it possible to increase the number of possible paths for the vehicle. This therefore makes it possible to increase traffic density in the transit zone (i.e. to increase the number of vehicles moving about simultaneously in the transit zone) and consequently to increase the order preparation rate.

The first axis of extension of the vehicle may extend along the second horizontal direction. The dimension of the vehicle in the second horizontal direction may be coincident with a dimension of the vehicle, in particular the chassis, along the first axis of extension.

A plurality of other motorized vehicles may circulate in the transit zone and/or in the storage area. The route may be calculated in step a″ as a function of the current position of the other vehicles in the transit zone and/or in the storage area, to follow a path that avoids colliding with one of the other vehicles.

Each rack may comprise several pairs of uprights in the first horizontal direction, each upright extending in the vertical direction, the uprights of each pair of uprights being spaced apart from each other in the second horizontal direction, the cells of each column being arranged between two adjacent pairs of uprights in the first horizontal direction, the vehicle having a dimension in the first horizontal direction which is less than the distance separating two pairs of uprights in the first horizontal direction.

The first axis of extension of the vehicle may extend in the second horizontal direction. The dimension of the vehicle in the first horizontal direction may be coincident with a dimension of the vehicle, in particular of the chassis, in a direction perpendicular to the direction of the first axis of extension.

Each rack may comprise a meshing member such as a linear gear or a chain, extending vertically along each upright, the climbing means comprising one or more toothed wheels each configured to ensure the movement of the vehicle along an upright of a rack by engaging with the meshing member of the upright.

When ascending or descending, a rotational movement of each toothed wheel of the climbing means may be converted into a vertical movement of the vehicle along the uprights.

Each meshing member may be integral with the respective upright.

Each toothed wheel of the climbing means of the vehicle may be movable between a retracted position in which the wheel is housed in or above the chassis and a deployed position in which the wheel projects laterally from the chassis. Step e may comprise a subsidiary step e1 comprising the deployment of each toothed wheel of the climbing means, from the retracted position to the deployed position. Step g may comprise a subsidiary step g1 comprising the folding of each toothed wheel of the climbing means, from the deployed position to the retracted position. During step e1 or g1, each toothed wheel of the climbing means may be respectively deployed from the retracted position or folded from the deployed position, in a respective deployment direction which comprises a component in the first horizontal direction and in the second horizontal direction. In other words, a deployment axis of each toothed wheel of the deployment means may form an angle, preferably non-zero, with the first axis of extension of the vehicle and/or with a second axis of extension of the vehicle which is perpendicular to the first axis. It is thus understood that when the toothed wheels of the climbing means are in their retracted position, the vehicle is able to circulate under the racks (i.e. below the bottom level of the racks), and in particular in the passageways of the storage area, without bumping against the uprights of the racks. In this retracted configuration, the vehicle may have a dimension in the first horizontal direction that is less than a distance separating two pairs of uprights in the first horizontal direction. Conversely, in their deployed position, the toothed wheels of the climbing means may be arranged to be facing an upright in the second horizontal direction. Also, in this deployed configuration, the vehicle may have a dimension in the first horizontal direction that is greater than a distance separating two pairs of uprights in the first horizontal direction.

The vehicle chassis and the container loaded on the vehicle chassis may have a cumulative height in the vertical direction that is less than the dimension in the vertical direction of the free space in each column of each rack.

Furthermore, the deployment of each climbing means may be carried out in a translational movement, preferably a single horizontal movement. Such deployment of the climbing means allows reducing the height of the vehicle, i.e. rendering it more vertically compact, and thus allows lowering the bottom level of the racks in order to increase storage capacity.

The method may comprise a step h carried out after step g and comprising the moving of the motorized vehicle across the floor in the second horizontal direction in the passageway until the vehicle is located in the transit zone, the orientation of the vehicle preferably remaining fixed during step h.

The transit zone may comprise at least one order preparation station. The method may comprise a step i carried out after step g comprising the moving of the vehicle across the floor in the transit zone to the order preparation station, the orientation of the vehicle preferably remaining fixed during step i.

Step i may be carried out after step H.

### BRIEF DESCRIPTION OF DRAWINGS

Other features, details and advantages will become apparent upon reading the detailed description below, and upon analyzing the attached drawings, in which:

FIG. 1 is a schematic view of a storage area and a transit zone in which a fleet of motorized vehicles circulates for order preparation;

FIG. 2 includes FIGS. 2a and 2b which respectively represent: a functional diagram of a method for preparing an order by means of at least one motorized vehicle moving between the storage area and the transit zone of FIG. 1, and a functional diagram of one of the steps of the method of FIG. 2a;

FIG. 3 is a schematic view of several variant routes of the motorized vehicle during the method of FIG. 2;

FIG. 3bis is a schematic view of other variant routes of the motorized vehicle during the method of FIG. 2;

FIG. 4 is a perspective view of the vehicle used in the method of FIG. 2;

FIG. 5 is a view of a means for moving the vehicle across the floor, used in the method of FIG. 2;

FIG. 6 is a section view of the means of FIG. 5 in section plane V-V;

FIG. 7 is a schematic view of the storage area and the transit zone of FIG. 1 in which motorized vehicles circulate, and which illustrates dimensional characteristics of the vehicles with respect to the storage area and to the transit zone.

### DESCRIPTION OF EMBODIMENTS

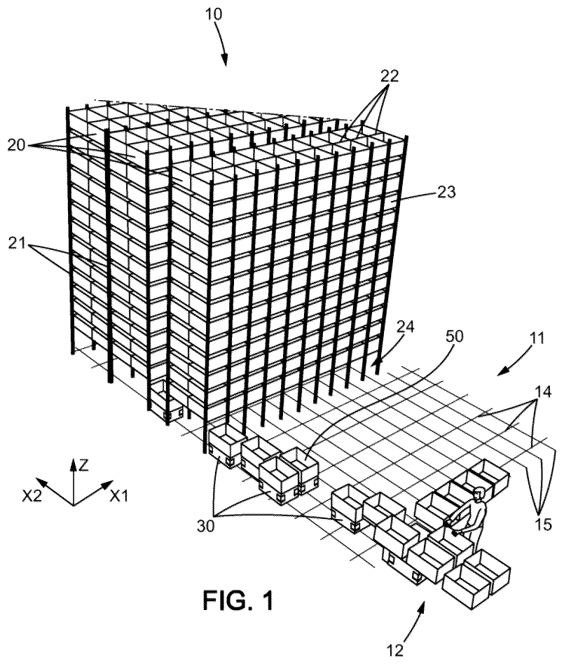

Reference is first made to FIG. 1 which represents a warehouse comprising a storage area 10 and a transit zone 11 for the preparation of an order. In the remainder of the description, reference is made to a vertical direction Z, a first horizontal direction X1, and a second horizontal direction X2. It is understood that vertical direction Z is perpendicular to first horizontal direction X1 and to second horizontal direction X2. In addition, second horizontal direction X2 is perpendicular to first

Storage area 10 firstly comprises a plurality of racks 20. Each rack 20 is served by at least one aisle Ai extending in first horizontal direction X1. Each rack 20 comprises several pairs of uprights 21 in first horizontal direction X1. Each upright 21 extends in vertical direction Z. Uprights 21 of each pair of uprights 21 are spaced apart from each other in second horizontal direction X2. Each upright 21 has a dimension 211 in the first horizontal direction. Each rack 20 forms a plurality of rack columns 22, arranged one after the other along first horizontal direction X1. Each rack column 22 comprises a plurality of storage cells 23, adapted to contain a container 50 which itself contains at least one item. Cells 23 of each column 22 are arranged between two successive pairs of uprights 21 in first horizontal direction X1. In the example illustrated, each cell 23 can receive two containers 50, one behind the other in second horizontal direction X2. Here, containers 50 are parallelepipedal in shape. Cells 23 of each column 22 are superimposed in several levels along vertical direction Z between a bottom level and a top level. Cell 23 of the bottom level is above floor level.

Each column 22 therefore comprises a free space 24 formed vertically between floor level and cell 23 of the bottom level. Storage area 10 thus comprises a plurality of passageways Pi extending at floor level in second horizontal direction X2, each passageway Pi passing under at least one cell 23, i.e. passing through free space 24 of one of columns 22 of each rack 20.

Transit zone 11 is adjacent to storage area 10 in second horizontal direction X2. Each passageway Pi leads into transit zone 11. Transit zone 11 comprises at least one order preparation station 12 where an operator retrieves the items in order to assemble said order.

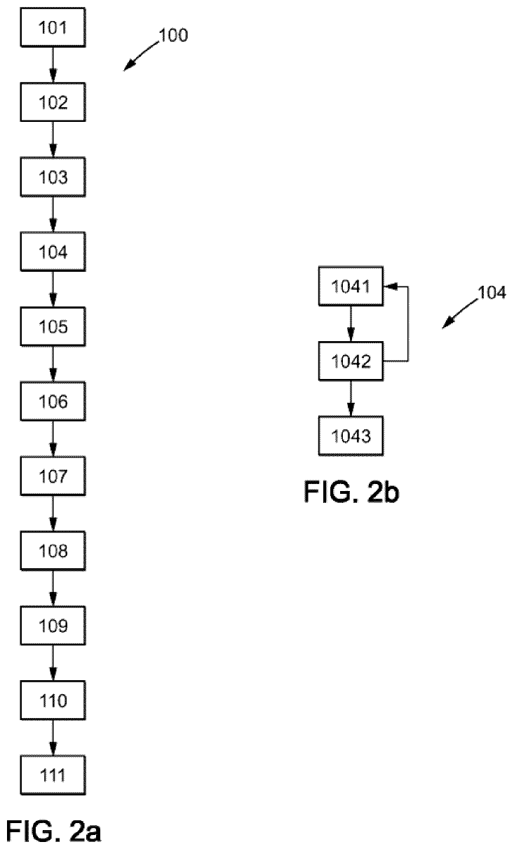

As can be seen in FIG. 2, storage area 10 and transit zone 11 are provided with a guidance tracing on the floor, intended to guide a vehicle 30 across the floor (described in more detail below). The guidance tracing comprises first rectilinear strips 14 in first horizontal direction X1 and second rectilinear strips 15 in second horizontal direction X2. Each aisle Ai of storage area 10 therefore comprises one of first strips 14 in first horizontal direction X1. Each passageway Pi of storage area 10 therefore partly comprises one of second strips 15 in second horizontal direction X2. The guidance tracing thus forms a grid. Strips 14; 15 may be implemented as a covering fixed to the floor (for example by gluing) or may be painted directly on the floor.

A fleet of motorized vehicles 30 ensures the transport of containers 50 between storage area 10 and order preparation station 12.

It is noteworthy that storage area 10 and transit zone 11 are each without any rails on the floor to guide vehicles 30.

With reference to FIGS. 2a, 3, and 7, a method 100 for preparing an order is now described by means of a motorized vehicle 30 moving between storage area 10 and transit zone 11.

Method 100 comprises a first step 101. First step 101 comprises associating vehicle 30 located in an initial position in transit zone 11 with a container to be collected in the storage area. Container 50 is arranged inside a collection cell 23c among the plurality of cells 23 of storage area 10. Container 50 may comprise one or more items to be collected in order to prepare the order.

First step 101 may comprise a first subsidiary step which comprises selecting the container to be brought from storage area 10, which allows establishing the position of collection cell 23c. The position of collection cell 23c is identified here by: aisle Ai which serves rack 20 where collection cell 23c is located, column 22 of rack 20 where collection cell 23c is located, and the level at which collection cell 23c is located in column 22.

Vehicle 30 here is an automated guided vehicle (AGV). For this purpose, vehicle 30 comprises an automated guidance unit.

First step 101 may comprise a second subsidiary step which comprises establishing communication with vehicle 30 located at the initial position in transit zone 11, for example by means of a wireless communication network such as WiFi, WiMAX, IWLAN, GSM, GPRS, UMTS (registered trademarks).

Method 100 comprises a second step 102. Second step 102 comprises transmitting the position of collection cell 23c to the automated guidance unit of the vehicle.

Method 100 comprises a third step 103. Third step 103 comprises sending instructions to the automated guidance unit of vehicle 30 to calculate a route between the initial position of vehicle 30 and the position of collection cell 23c. The calculated route here comprises only the (one or more) movement(s) of vehicle 30 in first horizontal direction X1 and/or the (one or more) movements in second horizontal direction X2. In particular, the route is calculated in third step 103 to follow a path selected among the first strips and second strips 15. Also, the route is calculated as a function of the current or planned position of the other vehicles 30 of the fleet within transit zone 11 and/or within storage area 10, in order to establish a path that avoids colliding with one of the other vehicles 30. For this purpose, provision may be made to send to the automated guidance unit, in real time, the current position of the other vehicles 30 of the fleet and/or their planned movement paths.

Alternatively, second step 102 and third step 103 may be replaced by a calculation of the route between the initial position of vehicle 30 and the position of collection cell 23c by a central control unit located remotely from the vehicle, and a sending of the route to vehicle 30.

Method 100 comprises a fourth step 104. Fourth step 104 comprises moving vehicle 30 across the floor in transit zone 11 at least in first horizontal direction X1 so as to align the vehicle, in a second horizontal direction X2, with the passageway Pi of storage area 10 that leads to column 22 where collection cell 23c is located.

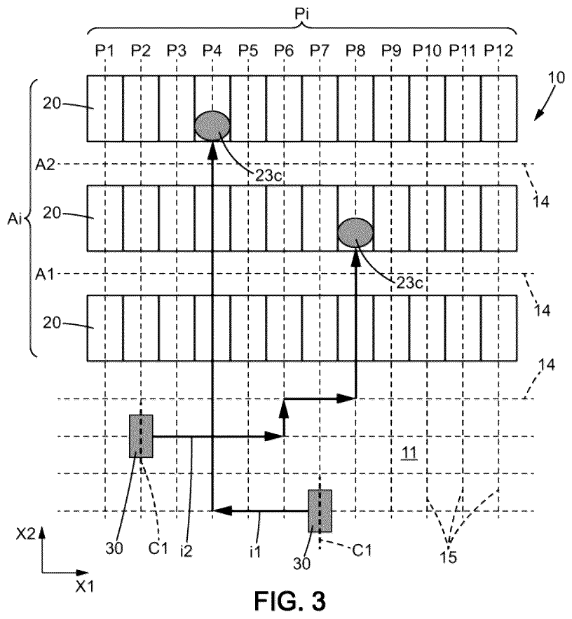

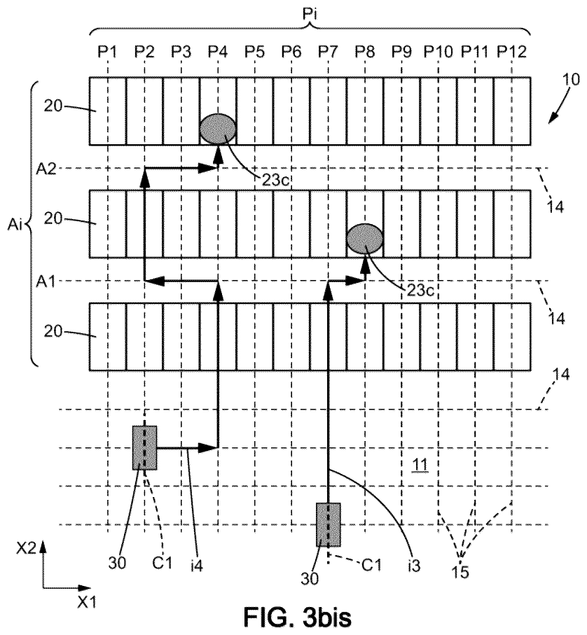

According to a first variant route il visible in FIG. 3, the moving of vehicle 30 across the floor in transit zone 11 during fourth step 104 may be carried out in first horizontal direction X1 only. Alternatively, according to a second variant route i2 also visible in FIG. 3, fourth step 104 may comprise a first subsidiary step 1041 comprising the moving of motorized vehicle 30 across the floor within transit zone 11 in first horizontal direction X1, a second subsidiary step 1042 comprising the moving of motorized vehicle 30 across the floor within transit zone 11 in second horizontal direction X2, and a third subsidiary step 1043 comprising the moving of motorized vehicle 30 across the floor within transit zone 11 in first horizontal direction X1 so as to align the vehicle, in second horizontal direction X2, with passageway Pi leading to column 22 where collection cell 23c is located. As shown in FIG. 2b, first subsidiary step 1041 and second subsidiary step 1042 of fourth step 104 may be repeated one or more times before carrying out third subsidiary step 1043 of fourth step 104. The change of direction in the movement of vehicle 30, between first horizontal direction X1 and second horizontal direction X2, is described in more detail below.

To carry out such movements across the floor, vehicle 30 comprises a chassis 31 extending along a first horizontal axis of extension C1 and means for horizontal movement adapted to move chassis 31 across the floor in at least two perpendicular directions. First axis of extension C1 of chassis 31 is considered to be perpendicular to vertical direction Z.

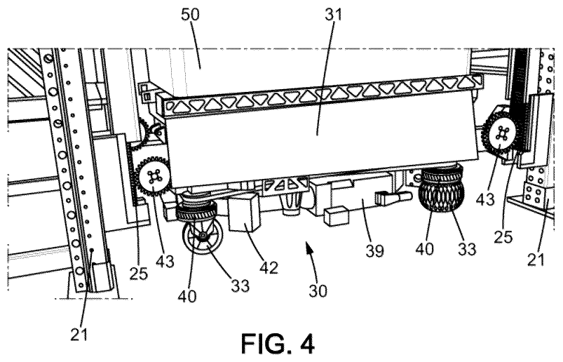

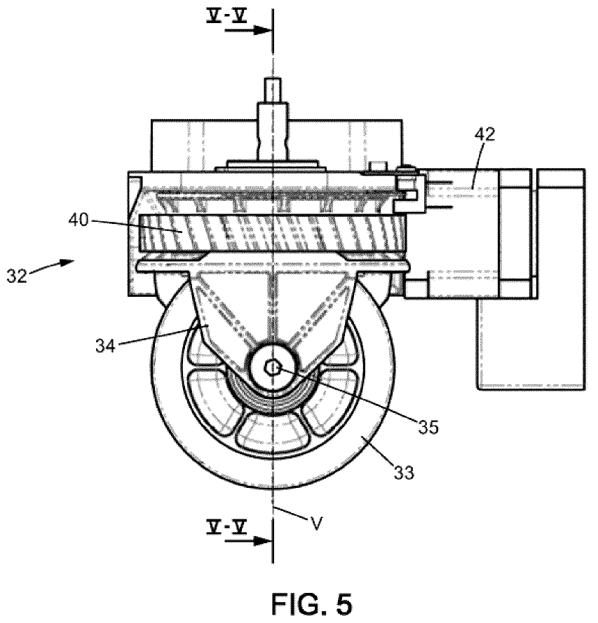

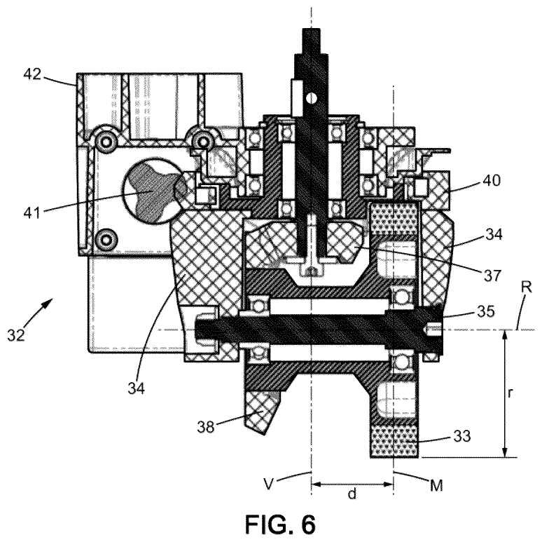

We now refer to FIGS. 4 to 6 which show vehicle 30 in more detail. Chassis 31 of vehicle 30 is parallelepipedal in shape. Means for horizontal movement of vehicle 30 comprise several wheel assemblies 32. Vehicle 30 here comprises four wheel assemblies 32, each wheel assembly 32 being arranged at a lower corner of chassis 31.

Each wheel assembly 32 comprises a wheel 33 having an axis of revolution R perpendicular to vertical direction Z. It is understood that axis of revolution R of wheel 33, about which wheel 33 rotates in order to move vehicle 30, extends in second horizontal direction X2 during fourth step 104 and in first horizontal direction X1 during fifth step 105.

Each wheel assembly 32 also comprises connecting means for connecting wheel 33 to chassis 31. The connecting means may comprise a fork on which wheel 33 is mounted so as to rotate about its axis of revolution R. The fork comprises two flanges 34 and a shaft 35. Flanges 34 are arranged one on either side of wheel 33 along the direction of axis of revolution R of wheel 33. Shaft 35 extends along axis of revolution R of wheel 33, between flanges 34. Shaft 35 is fixed to flanges 34. In the current case, shaft 35 passes through a hole in each of flanges 34 and is secured to flanges 34 by a nut which engages with a threaded portion of shaft 35. Wheel 33 is thus mounted on shaft 35 so as to rotate about its axis of revolution R.

The means for horizontal movement are further configured to move freely across the floor without any rails for guidance, in particular in the two perpendicular directions. Such a mode for the movement of vehicle 30 allows for a faster and more flexible installation of storage area 10 and transit zone 11. Finally, the noise footprint is also reduced, providing increased comfort for the human operators working in storage area 10 and/or in transit zone 11.

Each wheel assembly 32 comprises drive means for rotating wheel 33 about its axis of revolution R relative to chassis 31. The drive means comprise a first bevel gear 37 and a second bevel gear 38 which are arranged relative to each other so as to form a bevel gearing. First bevel gear 37 is coaxial with vertical axis V and second bevel gear 38 is coaxial with axis of revolution R of wheel 33. Wheel 33 and second bevel gear 38 are arranged one on either side of vertical axis V. Vehicle 30 here comprises an actuator 39 for actuating the drive means of each wheel assembly 32. Alternatively, each wheel assembly 32 may comprise a respective actuator for actuating the drive means.

Method 100 comprises a fifth step 105. Fifth step 105 comprises a change of direction in the movement of the vehicle, from first horizontal direction X1 to second horizontal direction X2, this change of direction being carried out while maintaining a fixed vehicle orientation relative to first horizontal direction X1 and to second horizontal direction X2. In particular, fifth step 105 comprises the pivoting of wheel 33 of each wheel assembly 32 about a vertical axis V in preparation for moving vehicle 30 in second horizontal direction X2. During fifth step 105, wheel 33 of each assembly is pivoted about vertical axis V so as to pivot axis of revolution R of wheel 33 about vertical axis V, from second horizontal direction X2 to first horizontal direction X1.

To do this, each wheel assembly 32 comprises means for changing the direction of movement. These means for changing the direction of movement comprise pivoting means for pivoting wheel 33 and connecting means about a vertical axis V relative to chassis 31. Vertical axis V intersects axis of revolution R of wheel 33. The pivoting means of wheel 33 comprise a toothed wheel 40 fixed to the fork and mounted to pivot about the vertical pivot axis V of wheel 33, and a worm screw 41 meshing with toothed wheel 40.

Each wheel assembly 32 here comprises an actuator 42 for actuating the pivoting means by driving worm screw 41 to rotate about its axis of extension. Actuator 42 may comprise a motor fixed to chassis 31 of vehicle 30 and comprising an output shaft connected to worm screw 41. Alternatively, a single actuator may be provided to actuate the pivoting means of each wheel assembly 32.

Performing a 90° change of direction in the movement of vehicle 30, between first horizontal direction X1 and second horizontal direction X2, by turning only wheel 33 and the connecting means of wheel 33, is advantageously faster than turning the entire chassis 31 of the vehicle. In particular, a gain of 2 seconds has been observed for a 90° change of direction in the movement of vehicle 30. The order preparation rate is therefore further increased.

Furthermore, wheel 33 and the connecting means of each wheel assembly 32 are pivoted simultaneously about the corresponding vertical axis V so as to pivot axis of revolution R of wheel 33 of each wheel assembly 32 about vertical axis V, from second horizontal direction X2 to first horizontal direction X1.

Finally, wheel 33 of each wheel assembly 32 is blocked from rotating about its axis of revolution R during fifth step 105. In other words, wheel 33 is pivoted about vertical axis V without being rotated about axis of revolution R. Thus, the orientation of vehicle 30 remains fixed when the direction of movement of the vehicle changes. Also, it is not necessary to act on wheel 33 via the drive means in order to compensate for a rotation of wheel 33 about its axis of revolution R when it pivots about vertical axis V. This allows reducing the energy consumption of the vehicle.

This may be obtained by a relative difference between the ratio of the radius r of wheel 33 and the distance d along axis of revolution R that separates a centre plane M of wheel 33 and vertical axis V, and the reduction ratio between second bevel gear 38 and first bevel gear 37, being less than or equal to 2%. The reduction ratio between second bevel gear 38 and first bevel gear 37 corresponds to the ratio between the number of teeth of second bevel gear 38 and the number of teeth of first bevel gear 37. Centre plane M of wheel 33 is a plane perpendicular to axis of revolution R of wheel 33 and is equidistant, along the direction of axis of revolution R of wheel 33, from a first face and a second face of wheel 33 which are opposite each other along the direction of axis of revolution R of wheel 33.

Finally, the change of direction of vehicle 30 carried out between subsidiary steps 1041, 1042, 1043 of fourth step 104 may be implemented in a manner similar to fifth step 105.

Method 100 comprises a sixth step 106. Sixth step 106 comprises moving the motorized vehicle 30 across the floor in second horizontal direction X2 in passageway Pi of storage area 10 which leads to column 22 where collection cell 23c is located, and possibly beforehand in transit zone 11, until vehicle 30 is located in aisle Ai of storage area 10 serving rack 20 where collection cell 23c is located. For example, in the case of first route variant i1, the movement of motorized vehicle 30 across the floor in second horizontal direction X2 comprises a first part in transit zone 11 and a second part in the corresponding passageway Pi. On the other hand, in the case of second route variant i2, the movement of motorized vehicle 30 across the floor in second horizontal direction X2 takes place only in the corresponding passageway Pi.

It is noteworthy that the orientation of vehicle 30 remains fixed during fourth step 104, fifth step 105, and sixth step 106.

As described above, the means for horizontal movement are adapted to maintain a fixed orientation of first axis of extension C1 of chassis 31. Thus, the orientation of first axis of extension C1 of chassis 31 of vehicle 30 remains fixed from fourth step 104 to sixth step 106. In particular, the direction of first axis of extension C1 of chassis 31 of vehicle 30 here remains coincident with second horizontal direction X2.

Vehicle 30 therefore does not rotate its chassis 31 when the direction of movement of vehicle 30 changes by 90° during fifth step 105. Chassis 31 of vehicle 30 does not pivot on itself. Thus, the movement of vehicle 30 requires less floor space during its trip to collection cell 23c, in particular during the 90° change of direction in the movement of vehicle 30 between fourth step 104 and sixth step 106. The minimum floor space required is strictly equal to the surface area occupied by chassis 31 of vehicle 30 due to its dimensions. For example, the floor space occupied by vehicle 30 during the 90° change of direction between first horizontal direction X1 and second horizontal direction X2 is reduced by a factor equal to √(2) compared to a vehicle 30 of equivalent dimensions in which chassis 31 would rotate during a 90° change of direction. Thus, the number of vehicles 30 in transit at the same time in transit zone 11 may be increased while avoiding any extension to the surface area of transit zone 11. As a result, the order preparation rate can be increased.

Furthermore, as chassis 31 of vehicle 30 is not rotated, this allows reducing or even eliminating a recalibration of the position of chassis 31 of the robot relative to the environment (relative to racks 20 for example) after the 90° change of direction between the movement in first horizontal direction X1 of fourth step 104 and the movement in second horizontal direction X2 of sixth step 106. The movement of vehicle 30 is therefore more precise and easier to implement. Also, method 100 for order preparation is carried out more quickly and more safely.

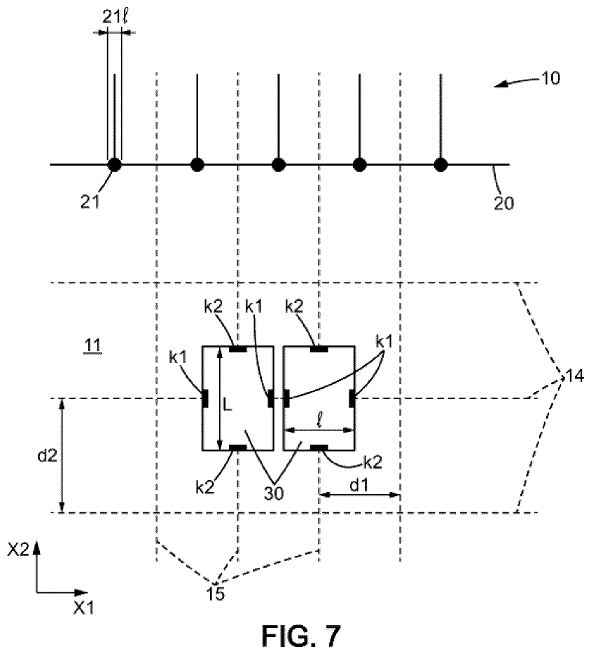

According to the example illustrated in FIGS. 3 and 7, a dimension of vehicle 30 along second horizontal direction X2 is coincident with a length L of vehicle 30, in particular of chassis 31, and considered along first axis of extension C1. Similarly, a dimension of vehicle 30 along first horizontal direction X1 is coincident here with a width I of vehicle 30, in particular of chassis 31, and considered along a direction perpendicular to the direction of first axis of extension C1. Width I of vehicle 30 may be equal to 450 mm. Length L of vehicle 30 may be equal to 650 mm.

Due to the non-rotation of chassis 31 of the vehicle, two consecutive second strips 15 may advantageously be spaced apart from each other in first horizontal direction X1 in transit zone 11 by a first distance d1 that is between 500 mm and 600 mm, preferably between 525 mm and 575 mm, and more preferably equal to 560 mm. Additionally or alternatively, a first relative difference between first distance d1 in first horizontal direction X1 separating two consecutive second strips 15 in transit zone 11, and width I of vehicle 30, may be between 0% (bound excluded) and 35%, preferably between 0% (bound excluded) and 30%, more preferably between 0% (bound excluded) and 25%. Also, the first distance is determined so as to be substantially greater (i.e. about 1 to 50 mm for example) than the sum of width I of vehicle 30 and twice the dimension 211 of upright 21 along the first horizontal direction.

Similarly, two consecutive first strips 14 may advantageously be spaced apart from each other along second horizontal direction X2 in transit zone 11 by a second distance d2 that is between 700 mm and 800 mm, preferably between 725 mm and 775 mm, and more preferably equal to 750 mm. Additionally or alternatively, a second relative difference between second distance d2 along second horizontal direction X2 separating two consecutive first strips 14 in transit zone 11, and length L of the vehicle, may be between 0% (bound excluded) and 25%, preferably between 0% (bound excluded) and 20%, more preferably between 0% (bound excluded) and 15%.

In the case of a vehicle that changes direction by pivoting on itself, and as is particularly apparent in FIG. 7 where two vehicles are next to each other in the first horizontal direction, it is necessary for the first relative difference to be greater than the ranges of values described above in the context of this description, in order to avoid a collision between the two vehicles. The same observation would also be made concerning the second relative difference in the case where the two vehicles are side by side in the second horizontal direction. It is therefore understood here that the method according to the present description allows arranging more first strips 14 and second strips 15 in transit zone 11. This allows increasing the number of possible routes for vehicle 30. Thus, eliminating the rotation of vehicles 30 of the fleet and having a higher number of first and second strips 14, 15 allow increasing the number of vehicles 30 moving simultaneously in transit zone 11 and consequently further increasing the order preparation rate.

Vehicle 30 may comprise a first pair of sensors K1 arranged one on either side of vehicle 30 in first horizontal direction X1 and a second pair of sensors K2 arranged one on either side of vehicle 30 in second horizontal direction X2. The sensors of the first pair of sensors may be mounted on vehicle 30 one on either side of the chassis along the first axis of extension, and the sensors of the second pair of sensors K2 may be mounted on vehicle 30 one on either side of the chassis along a second axis of extension that is perpendicular to the first axis.

Depending on the direction of movement of vehicle 30, one among first pair of sensors K1 and second pair of sensors K2 may be adapted to control the alignment of vehicle 30 in the first and second horizontal directions X2 respectively, and the other among first pair of sensors K1 and second pair of sensors K2 may be adapted to identify the position of vehicle 30 in the first and second horizontal directions X2 respectively.

When vehicle 30 moves in first horizontal direction X1:
first pair of sensors K1 may be adapted to detect a deviation or misalignment of vehicle 30 in first horizontal direction X1 relative to a first strip 14 being followed by vehicle 30. If necessary, the alignment of vehicle 30 in first horizontal direction X1 may be corrected; and
second pair of sensors K2 may be adapted to count second strips 15 that are crossed. Associated with a wheel revolution counter, second pair of sensors K2 may thus allow identifying the position of vehicle 30 in second horizontal direction X2.

When vehicle 30 moves in second horizontal direction X2:
second pair of sensors K2 may be adapted to detect a deviation or misalignment of vehicle 30 in second horizontal direction X2 relative to a second strip 14 being followed by vehicle 30. If necessary, the alignment of vehicle 30 in second horizontal direction X2 may be corrected; and
first pair of sensors K1 may be adapted to count first strips 14 that are crossed. Associated with a wheel revolution counter, first pair of sensors K1 may thus allow identifying the location of vehicle 30 in first horizontal direction X1.

This ensures a positioning centred on the strips. This also ensures that vehicle 30 can travel through the passageways of the storage area without bumping into the uprights of the racks.

The sensors of first pair of sensors K1 and/or of second pair of sensors may be optical sensors. In particular, they may be LED sensors, preferably 750 nm. The sensors of first pair of sensors K1 and/or of second pair of sensors may be adapted to detect a colour difference between black and white. For this purpose, first strip 14 and second strip 15 may comprise black borders which frame a white central portion.

To enable vehicle 30 to move through one of passageways Pi, the dimension of vehicle 30 in first horizontal direction X1 is less than the distance separating two consecutive pairs of uprights 21 in first horizontal direction X1.

Method 100 comprises a seventh step 107. Seventh step 107 comprises moving vehicle 30 in vertical direction Z until vehicle 30 is located vertically at the level of collection cell 23c.

To do this, vehicle 30 comprises climbing means adapted to move chassis 31 in vertical direction Z. The climbing means comprise one or more toothed wheels 43, each being configured to ensure the movement of vehicle 30 along an upright 21 of a rack, by engaging with a meshing member 25 of upright 21. Here, each rack 20 comprises a meshing member 25, in this case a linear gear, extending vertically along each upright 21. When ascending or descending, a rotational movement of each toothed wheel 43 of the climbing means is therefore converted into a vertical movement of vehicle 30 along uprights 21. Meshing member 25 is integral with the respective upright 21.

Each toothed wheel 43 of the climbing means is movable between a retracted position in which wheel 33 is housed in or above chassis 31 and a deployed position in which wheel 33 projects laterally from chassis 31. Seventh step 107 comprises a preliminary subsidiary step comprising the deployment of each toothed wheel 43 of the climbing means, from the retracted position to the deployed position.

The climbing means comprise at least a first toothed wheel 43 capable of engaging with meshing member 25 of one of uprights 21 of a first rack 20, and a second toothed wheel 43 capable of engaging with meshing member 25 of one of uprights 21 of a second rack 20 adjacent to the first rack, uprights 21 being in line with each other in second horizontal direction X2. In this case, the climbing means comprise four toothed wheels 44, which are:
two toothed wheels 43 able to engage with two uprights 21 of a first rack, the two uprights 21 of first rack 20 being successive in first horizontal direction X1;
two toothed wheels 43 able to engage with two uprights 21 of a second rack 20 adjacent to first rack 20 in second horizontal direction X2, the two uprights 21 of second rack 20 being successive in first horizontal direction X1 and respectively facing one of the successive uprights 21 of first rack 20 in second horizontal direction X2.

Method 100 comprises an eighth step 108. Eighth step 108 comprises the loading of container 50 held in collection cell 23c, onto the vehicle. Vehicle 30 comprises gripping means for this purpose. Here, the shape of chassis 31 of vehicle 30 is adapted to receive a container.

Method 100 comprises a ninth step 109. Ninth step 109 comprises the moving of vehicle 30 in vertical direction Z until vehicle 30 is at floor level, in particular by means of the climbing means. Ninth step 109 comprises a final subsidiary step (i.e. when vehicle 30 is at floor level) which comprises folding each toothed wheel 43 of the climbing means from the deployed position to the retracted position.

Method 100 comprises a tenth step 110. Tenth step 110 comprises the moving of the motorized vehicle 30 across the floor in second horizontal direction X2 in passageway Pi until vehicle 30 is again located in transit zone 11. The orientation of vehicle 30 preferably remains fixed during tenth step 110.

To allow vehicle 30 carrying container 50 to move along passageway Pi, chassis 31 of vehicle 30 and container 50 loaded on chassis 31 of vehicle 30 have a cumulative height in vertical direction Z that is less than the dimension in vertical direction Z of the free space 24 formed by each column 22 of each rack 20.

Method 100 comprises an eleventh step 111. Eleventh step 111 comprises the moving of vehicle 30 across the floor in transit zone 11, to order preparation station 12. Preferably here as well, the orientation of vehicle 30 remains fixed during eleventh step 111.

The invention is not limited to the examples described above and is capable of numerous variants.

FIG. 3b is illustrates a first variant represented by a third route variant i3. In the first variant, the fourth, fifth and sixth steps 104, 105, 106 differ from the method described above. According to this first variant, fourth step 104 comprises the moving of vehicle 30 across the floor in second horizontal direction X2, within the transit zone and within one of the passageways of the storage area, until vehicle 30 is located in aisle Ai which serves rack 20 where collection cell 23c is located. According to third route variant i3, the moving of vehicle 30 across the floor in storage area 10 and transit zone 11 during fourth step 104 may be carried out solely in second horizontal direction X2.

According to the first variant, fifth step 105 comprises a change of direction in the movement of the vehicle from second horizontal direction X2 to first horizontal direction X1, this change of direction being performed while maintaining a fixed orientation of the vehicle with respect to first horizontal direction X1 and to second horizontal direction X2. Fifth step 105 is carried out in a similar manner to that described above. It is noteworthy that here, the change of direction takes place in the storage area.

According to the first variant, sixth step 106 comprises the moving of motorized vehicle 30 across the floor in first horizontal direction X1 in aisle Ai which serves rack 20 where collection cell 23c is located, until the vehicle is at the foot of column 22 of rack 20 where the collection cell is located.

FIG. 3bis also illustrates a second variant represented by a fourth route variant i4. The second variant results from combining the method described above and the first variant. Thus, in the second variant, the fourth, fifth, and sixth steps 104, 105, 106 as initially described are first carried out, and the fourth, fifth, and sixth steps 104, 105, 106 as described with reference to the first variant are then carried out.

One can also see in the fourth route variant i4 that fourth step 104 according to the first variant may comprise a first subsidiary step 1041 comprising the moving of vehicle 30 across the floor within a first passageway P5 in second horizontal direction X2 until the vehicle is located in a first aisle A1, a second subsidiary step 104 comprising the moving of vehicle 30 across the floor in first aisle A1 in first horizontal direction X1 until the vehicle is aligned in second horizontal direction X2 with a second passageway P2, and a third subsidiary step 1043 comprising the moving of vehicle 30 across the floor in second passageway P2 in second horizontal direction X2 until the vehicle is located in a second aisle A2, second aisle A2 here being the aisle which serves the rack where collection cell 23c is located. Here, too, the first subsidiary step and second subsidiary step may be repeated one or more times before the third subsidiary step is implemented. The change of direction of vehicle 30 carried out between the subsidiary steps may also be implemented in a manner similar to fifth step 105.

1-19. (canceled)

20. A method for preparing an order by means of at least one motorized vehicle moving between a storage area and a transit zone, the method comprising:
a. Associating the vehicle, located in an initial position in the transit zone, with a container to be collected in the storage area, the container being arranged inside a collection cell among a plurality of cells of the storage area;
according to a first possibility, the method comprising the steps of:
bi. Moving the vehicle across the floor in the transit zone at least in a first horizontal direction so as to align the vehicle, in a second horizontal direction, with a passageway of the storage area;
ci. Making at least one change of direction;
di. Moving the vehicle across the floor in at least one passageway in the second horizontal direction until the vehicle is located in an aisle of the storage area, preferably an aisle which serves a rack where the collection cell is located;
according to a second possibility, the method comprising the steps of:
bii. Moving the vehicle across the floor in at least one passageway in the second horizontal direction until the vehicle is located in an aisle of the storage area, preferably the aisle which serves a rack where the collection cell is located;
cii. Making at least one change of direction;
dii. Moving the vehicle across the floor in the aisle of the storage area in the first horizontal direction so as to align the vehicle, in the second horizontal direction, with the collection cell;
the method further comprising the steps of:
e. Moving the vehicle in a vertical direction until the vehicle is vertically located at the level of the collection cell;
f. Loading onto the vehicle the container held in the collection cell, by means of gripping means of the vehicle;
g. Moving the vehicle in the vertical direction until the vehicle is at floor level;
and wherein:
the vehicle is configured to move freely across the floor, the floor having no rails for guidance in the two perpendicular directions,
the orientation of the vehicle remains fixed during its movement across the floor in the transit zone and in the storage area during steps bi, bii, di, and dii, including during the change of direction made in steps ci and cii, and preferably during steps e and g.

21. The method according to claim 20, the vehicle comprising:
a chassis extending along a first horizontal axis of extension;
means for horizontal movement, adapted to move the chassis across the floor in at least two perpendicular directions while maintaining a fixed orientation of the first axis of extension of the chassis, the means for horizontal movement being configured to move freely across the floor which is without any rails for guidance in the two perpendicular directions;
climbing means adapted to move the chassis along the vertical direction Z; and
gripping means connected to the chassis and adapted to grasp a container in one of the cells and load it onto the chassis.

22. The method according to claim 21, the means for horizontal movement of the vehicle comprising at least one wheel assembly which comprises:
a wheel having an axis of revolution perpendicular to the vertical direction, and connecting means for connecting the wheel to the chassis, the axis of revolution of the wheel which the wheel rotates around in order to move the vehicle extending at least in the second horizontal direction during steps bi and dii and in the first horizontal direction during steps di and bii;
means for changing the direction of movement, comprising pivoting means for pivoting the wheel and the connecting means about a vertical axis relative to the chassis, the vertical axis intersecting the axis of revolution of the wheel,
steps ci and cii comprising the pivoting of the wheel and connecting means about the vertical axis so as to pivot the axis of revolution of the wheel about the vertical axis from the second horizontal direction to the first horizontal direction.

23. The method according to claim 22, wherein the wheel is blocked from rotating about its axis of revolution during steps ci and cii.

24. The method according to claim 22, the wheel assembly comprising drive means for rotating the wheel about its axis of revolution relative to the chassis, the drive means comprising a first bevel gear and a second bevel gear which are arranged relative to each other so as to form a bevel gearing, the first bevel gear being coaxial with the vertical axis and the second bevel gear being coaxial with the axis of revolution of the wheel, the wheel and the second bevel gear being arranged one on either side of the vertical axis, a relative difference between the ratio of the radius of the wheel and the distance along the axis of revolution that separates a centre plane of the wheel and the vertical axis, and the reduction ratio between the second bevel gear and the first bevel gear, being less than or equal to 2%.

25. The method according to claim 22, the means for horizontal movement of the vehicle comprising a plurality of wheel assemblies, steps ci and cii comprising the simultaneous pivoting of the wheel and of the connecting means of each wheel assembly about the corresponding vertical axis so as to pivot the axis of revolution of the wheel of each wheel assembly about the vertical axis, between the second horizontal direction and the first horizontal direction.

26. The method according to claim 20, wherein the storage area comprises several racks, each rack being served by at least one aisle extending in the first horizontal direction, each rack comprising a plurality of rack columns arranged one after the other in the first horizontal direction, each rack column comprising a plurality of storage cells adapted to contain a container, the cells of each column being superimposed in several levels along the vertical direction between a bottom level and a top level, each column comprising a free space formed vertically between the floor level and the cell of the bottom level, the storage area comprising a plurality of passageways extending at floor level in the second horizontal direction which is perpendicular to the first perpendicular direction, each passageway passing through the free space of one of the columns of each rack, and wherein the transit zone is adjacent to the storage area in the second horizontal direction.

27. The method according to claim 26, the vehicle comprising an automated guidance unit, the method comprising the steps of:
a′ Transmitting the position of the collection cell to the automated guidance unit of the vehicle, the position of the collection cell being identified by the aisle serving the rack where the collection cell is located, the column of the rack where the collection cell is located, and the level at which the collection cell is located in the column;
a″ Commanding the automated guidance unit of the vehicle to calculate a route between the initial position of the vehicle and the position of the collection cell, the route preferably comprising only a movement of the vehicle in the first horizontal direction and a movement of the vehicle in the second horizontal direction;
steps a′ and a″ being carried out between step a and step bi or bii.

28. The method according to claim 27, the storage area and the transit zone being provided with guidance tracing on the floor, intended to guide the vehicle across the floor, the guidance tracing comprising first rectilinear strips in the first horizontal direction and second rectilinear strips in the second horizontal direction, and wherein the route is calculated in step a“ to follow a path selected among the first strips and the second strips.

29. The method according to claim 28, the vehicle comprising a first pair of sensors arranged one on either side of the vehicle in the first horizontal direction and a second pair of sensors arranged one on either side of the vehicle in the second horizontal direction, and wherein, depending on the direction of movement of the vehicle, one among the first pair of sensors and second pair of sensors is adapted to monitor the alignment of the vehicle in the first and the second horizontal direction respectively, and the other among the first pair of sensors and second pair of sensors is adapted to identify the position of the vehicle in the first and the second horizontal direction respectively.

30. The method according to claim 28, wherein two adjacent second strips are spaced apart from each other in the first horizontal direction by a first distance that is between 500 mm and 600 mm, and preferably equal to 560 mm, at least in the transit zone, or wherein a relative difference between the first distance in the first horizontal direction separating two adjacent second strips in the transit zone and a dimension of the vehicle in the first horizontal direction is between 0% and 35%, preferably between 0% and 30%, more preferably between 0% and 25%.

31. The method according to claim 28, wherein two adjacent first strips are spaced apart from each other in the second horizontal direction by a second distance that is between 700 mm and 800 mm, and preferably equal to 750 mm, at least in the transit zone, or wherein a relative difference between the second distance in the second horizontal direction separating two adjacent first strips in the transit zone and a dimension of the vehicle in the second horizontal direction is between 0% and 25%, preferably between 0% and 20%, more preferably between 0% and 15%.

32. The method according to claim 27, wherein a plurality of other motorized vehicles circulate in the transit zone and/or in the storage area, and wherein the route is calculated in step a” as a function of the current position of the other vehicles in the transit zone and/or in the storage area, to follow a path that avoids colliding with one of the other vehicles.

33. The method according to claim 26, each rack comprising several pairs of uprights in the first horizontal direction, each upright extending in the vertical direction, the uprights of each pair of uprights being spaced apart from each other in the second horizontal direction, the cells of each column being arranged between two adjacent pairs of uprights in the first horizontal direction, the vehicle having a dimension in the first horizontal direction which is less than the distance separating two pairs of uprights in the first horizontal direction.

34. The method according to claim 33, the vehicle comprising:
a chassis extending along a first horizontal axis of extension;
means for horizontal movement, adapted to move the chassis across the floor in at least two perpendicular directions while maintaining a fixed orientation of the first axis of extension of the chassis, the means for horizontal movement being configured to move freely across the floor which is without any rails for guidance in the two perpendicular directions;
climbing means adapted to move the chassis along the vertical direction Z; and
gripping means connected to the chassis and adapted to grasp a container in one of the cells and load it onto the chassis,
each rack comprising a meshing member such as a linear gear or a chain, extending vertically along each upright, the climbing means comprising one or more toothed wheels each configured to ensure the movement of the vehicle along an upright of a rack by engaging with the meshing member of the upright.

35. The method according to claim 34, each toothed wheel of the climbing means of the vehicle being movable between a retracted position in which the toothed wheel is housed in or above the chassis and a deployed position in which the wheel projects laterally from the chassis, step e comprising a subsidiary step e1 comprising the deployment of each toothed wheel of the climbing means, from the retracted position to the deployed position, and step g comprising a subsidiary step g1 comprising the folding of each toothed wheel of the climbing means, from the deployed position to the retracted position.

36. The method according to claim 26, the vehicle comprising:
a chassis extending along a first horizontal axis of extension;
means for horizontal movement, adapted to move the chassis across the floor in at least two perpendicular directions while maintaining a fixed orientation of the first axis of extension of the chassis, the means for horizontal movement being configured to move freely across the floor which is without any rails for guidance in the two perpendicular directions;
climbing means adapted to move the chassis along the vertical direction Z; and
gripping means connected to the chassis and adapted to grasp a container in one of the cells and load it onto the chassis,
the chassis of the vehicle and the container loaded on the chassis of the vehicle having a cumulative height in the vertical direction that is less than the dimension in the vertical direction of the free space formed by each column of each rack.

37. The method according claim 20, the method comprising a step h carried out after step g and comprising the moving of the motorized vehicle across the floor in the second horizontal direction in the passageway until the vehicle is located in the transit zone, the orientation of the vehicle preferably remaining fixed during step h.

38. The method according to claim 20, the transit zone comprising at least one order preparation station, the method comprising a step i carried out after step g comprising the moving of the vehicle across the floor in the transit zone to the order preparation station, the orientation of the vehicle preferably remaining fixed during step i.
